(19) United States
(12) Patent Application Publication
(10) Pub. No.: US 2013/0221653 A1
(43) Pub. Date: Aug. 29, 2013

(54) Investment card

(71) Applicant: Harry William Powell, Griffin, GA (US)

(72) Inventor: Harry William Powell, Griffin, GA (US)

(21) Appl. No.: 13/385,543

(22) Filed: Feb. 24, 2012

(51) Int. Cl. B42D 15/00

(52) U.S. Cl. 283/79

(57) ABSTRACT

The present invention is called an investment card and its made from various materials and it serves as a voucher for an investment of choice including but not limited to stocks, bonds, gold, silver, platinum, insurance, CD's, or similar investment items that fluctuate in value. The cards are labeled with a value, with a title denoting what the card is redeemable, the name of the company it can be used with, a legal disclaimer, a dividend amount per share for stocks, any applicable expiration date and the brokering firm or company or entity that is putting the card out for purchase. The cards are redeemable at the varying brokering websites.

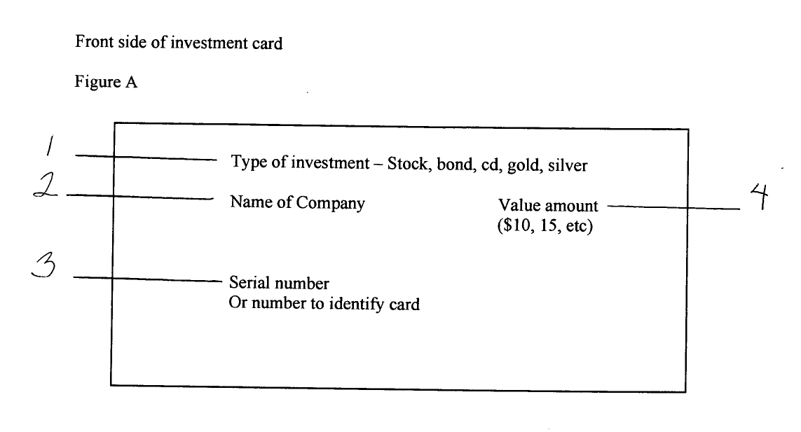

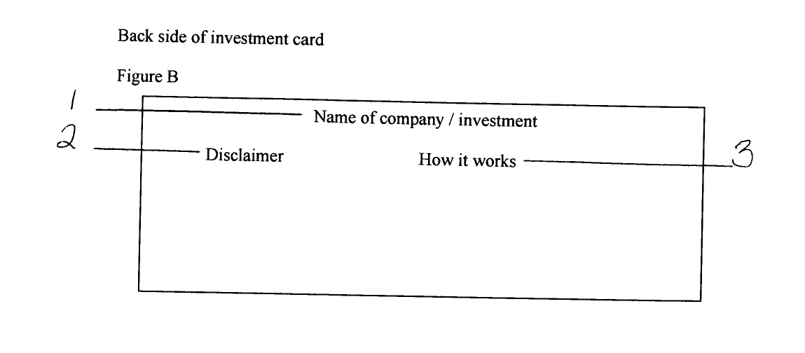

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

We are claiming small entity status.

### BACKGROUND OF THE INVENTION

This invention can be classified in the class of sales equipment. It can further be classified as a card that holds value that exceeds the material it is comprised of. The present invention is what we have called an “investment card.”

There is presently a need in the gift industry to enable a person to buy a gift of stocks, bonds, gold, silver, platinum, insurance, CD's, or similar investment items that fluctuate in value. These “investment cards” will be easily accessible for purchase to members of the public. The manner they will be sold in includes, but is not limited to, shops at airports, checkout registers and kiosks in shopping centers and train stations. This will enable the average consumer to easily purchase a card that serves as a voucher for the investment of their choice. The cards are redeemable at the varying brokering websites.

The cards are made of plastic and each one is labeled with a value and with a title denoting what the card is redeemable for. On each card will be the name of the company it can be used with, the value it holds, a legal disclaimer, a dividend amount per share for stocks, any applicable expiration date and the brokering firm or company or entity that is putting the card out for purchase.

### FIELD OF THE INVENTION

The present invention is of the art of sales equipment. Further, it is a card that holds a value separate and apart from the material the card itself is comprised of The value will be different for each card.

### DESCRIPTION OF RELATED ART

There are two inventions that are related to the present invention. The first is U.S. Pat. No. 4,093,276 entitled “Bipartite Stock Certificate.” This patent differs from the Present Invention because it is for an actual certificate that represents the amount of interest the owner has in the stock, whereas the present invention represents not an amount of interest but a predetermined value. It is only upon redemption that the purchaser will actually see how much interest has been purchased. The Investment Card can be likened to a check good for a purchase where the actual value or ownership is to be redeemed at the various brokering websites. Also the present invention can be purchased for various investments such as stocks, bonds, gold, silver, platinum; insurance, CD's, or similar investment items that fluctuate in value.

The second patent that is related art is U.S. Pat. No. 8,060,420. This patent is for a method for purchasing goods and services in transactions utilizing a valued card. The present invention differs from the above-mentioned patent in that it is not a method for purchasing a good or a service, rather it is a card used to purchase amounts of interest in certain investments such as stocks, bonds, gold, silver, platinum, insurance, CD's or similar investment items that fluctuate in value. Currently there is no way to purchase investment type cards.

### BRIEF SUMMARY OF THE INVENTION

There is presently a need in the gift industry to enable a person to buy a gift of stocks, bonds, gold, silver, platinum, insurance, CD's, or similar investment items that fluctuate in value. This need has resulted in the creation of the present invention aptly named “Investment Cards” and in the creation of the method in which they are used. These cards will be easily accessible for purchase to members of the public. The manner they will be sold in includes, but is not limited to, shops at airports, checkout registers and kiosks in shopping centers and train stations. This will enable the average consumer to easily purchase a card that serves as a voucher for the investment of their choice. The cards are then redeemable at the varying brokering websites. The method of use is the purchasing of the card, the registering at the various brokering sites and the actual redemption at each site.

The cards are made of plastic and each one is labeled with a value and with a title denoting what the card is redeemable for. On each card will be the type of investment, the value it holds, a legal disclaimer, a dividend amount per share for stocks, any applicable expiration date and the brokering firm or company or entity that is putting the card out for purchase.

### BRIEF DESCRIPTION OF THE DRAWINGS

Figure A is a representation of what the investment card will look like from a front perspective; and

Figure B is a representation of what the investment card will look like from a back perspective.

### DETAILED DESCRIPTION OF THE DRAWINGS

Figure A is a representation of what the front of the card will look like. Figure A, number 1 is where the type of investment will be placed. Figure A, number 2 is where the name of the company that the card can be used with will be placed. Figure A, number 3 is where the serial number will be placed. Figure A, number 4 is where the value amount of the card will be placed.

Figure B is a representation of what the backside of the card will look like. Figure B, number 1 is where the name of the company or the investment firm will be placed. Figure B, number 2 is where the legal disclaimer will be placed. Figure B, number 3 is where an explanation as to how the card functions will be placed.

### DETAILED DESCRIPTION OF THE INVENTION

This invention can be classified in the class of sales equipment. It can further be classified as a card that holds value that exceeds the material it is comprised of The present invention is what we have called an “investment card.”

There is presently a need in the gift industry to enable a person to buy a gift of stocks, bonds, gold, silver, platinum, insurance, CD's, or similar investment items that fluctuate in value. These “investment cards” will be easily accessible for purchase to members of the public. The manner they will be sold in includes, but is not limited to, shops at airports, checkout registers and kiosks in shopping centers and train stations. This will enable the average consumer to easily purchase a card that serves as a voucher for the investment of their choice. The cards are redeemable at the varying brokering websites.

The cards are made of plastic and each one is labeled with a value and with a title denoting what the card is redeemable for be it a stock or an insurance policy. On each card will be the name of the company it can be used with, the value it holds, a legal disclaimer, a dividend amount per share for stocks, any applicable expiration date and the brokering firm or company or entity that is putting the card out for purchase.

The actual value or ownership of the card is to be redeemed at the various sponsoring websites. The manner they are purchased is by going to a retail store or any of the various places the cards will be sold, and by purchasing the card. The card will be purchased for the face value plus a surcharge. The purchaser will have to go to the sponsoring firm's or company's website and register or create an account with the applicable company or firm. The purchaser then types in the numbers that are on the back of the card.

With regards to stocks, the cards themselves are not a share, rather they are an amount of ownership to be bought in a company. The cards will not be the tender of cash, only proof that stock in company has been paid for, for example, similar to a check.

### CONCLUSIONS

The foregoing description illustrates and describes the processes, machines, manufactures, compositions of matter, and other teachings of the present disclosure. Additionally, the disclosure shows and describes only certain embodiments of the processes, machines, manufactures, compositions of matter and other teachings disclosed, but, as mentioned above, it is to be understood that the teachings of the present disclosure are capable of use in various other combinations, modifications, and environments and is capable of changes or modification within the scope of the teachings as expressed herein, commensurate with the skill and/or knowledge of a person having ordinary skill in the relevant art. The embodiments described hereinabove are further intended to explain certain best modes known of practicing the processes, machines, manufactures, compositions of matter, and other teachings of the present disclosure in such, or other, embodiments and with the various modifications required by the particular applications or uses. Accordingly, the processes, machines, manufactures, compositions of matter, and other teachings of the present disclosure are not intended to limit the exact embodiments and examples disclosed herein.

1) we claim the above invention in its entirety.

2) we claim an invention called an investment card made from various materials that serves as a voucher for an investment of choice including but not limited to stocks, bonds, gold, silver, platinum, insurance, cd's, or similar investment items that fluctuate in value: The cards are labeled with a value, with a title denoting what the card is redeemable, the name of the company it can be used with, a legal disclaimer, a dividend amount per share for stocks, any applicable expiration date and the brokering firm or company or entity that is putting the card out for purchase. The cards are redeemable at the varying brokering websites.

3) We claim the method of use for the cards which is comprised of the card charging the card with a value, purchasing the card and logging onto the various brokering website to redeem it's value.
